(19) United States
(12) Patent Application Publication
(10) Pub. No.: US 2024/0166537 A1
(43) Pub. Date: May 23, 2024

(54) ELECTROCHEMICAL HYDROGEN-LOOPING SYSTEM FOR LOW-COST CO2 CAPTURE FROM SEAWATER

(71) Applicant: Battelle Memorial Institute, Richland, WA (US)

(72) Inventors: Litao Yan, Richland, WA (US); Wei Wang, West Richland, WA (US); Yuyan Shao, West Richland, WA (US)

(21) Appl. No.: 18/505,954

(22) Filed: Nov. 9, 2023

Related U.S. Application Data
(60) Provisional application No. 63/424,752, filed on Nov. 11, 2022.

(51) Int. Cl. C02F 1/461

(52) U.S. Cl. CPC C02F 1/4618; C02F 2001/46142; C02F 2101/10

(57) ABSTRACT

In some aspects, the techniques described herein relate to a method of capturing carbon from seawater, the method including: flowing input seawater including bicarbonate and having a pH greater than 8 through a center compartment of an electrolytic cell, wherein the center compartment is disposed between an anode compartment and a cathode compartment of the electrolytic cell; acidifying the input seawater in the center compartment with a proton, to form acidified seawater; generating carbon dioxide in the center compartment including reaction of the proton with the bicarbonate from the input seawater; flowing acidified seawater out of the center compartment; contacting the acidified seawater with hydroxide or a hydroxide salt from the cathode compartment to generate basified seawater having a pH greater than 9; and flowing hydrogen generated in the cathode compartment to the anode compartment.

### CROSS-REFERENCE TO RELATED APPLICATION

This application claims the benefit of priority to U.S. Provisional Patent Application Ser. No. 63/424,752 entitled “ELECTROCHEMICAL HYDROGEN-LOOPING SYSTEM FOR LOW-COST CO2 CAPTURE FROM SEAWATER,” filed Nov. 11, 2022, the disclosure of which is incorporated herein in its entirety by reference.

### STATEMENT AS TO RIGHTS TO DISCLOSURES MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND

Excess carbon dioxide contribute to climate change. Excess carbon dioxide can come from many sources. It is desirable to remove excess carbon dioxide to help curb climate change.

### SUMMARY OF THE INVENTION

In some aspects, the techniques described herein relate to a method of capturing carbon from seawater, the method including: flowing input seawater including bicarbonate and having a pH greater than 8 through a center compartment of an electrolytic cell, wherein the center compartment is disposed between an anode compartment and a cathode compartment of the electrolytic cell; acidifying the input seawater in the center compartment with a proton, to form acidified seawater; generating carbon dioxide in the center compartment including reaction of the proton with the bicarbonate from the input seawater; flowing acidified seawater out of the center compartment; contacting the acidified seawater with hydroxide or a hydroxide salt from the cathode compartment to generate basified seawater having a pH greater than 9; and flowing hydrogen generated in the cathode compartment to the anode compartment.

In some aspects, the techniques described herein relate to a system for capturing carbon dioxide from input seawater, the system including an electrolytic cell including: an anode compartment including a Pt/C catalyst coated carbon paper; a cathode compartment including a Pt/C catalyst coated carbon electrode; a center compartment abutting the anode compartment and cathode compartment and including a polytetrafluoroethylene bar disposed therein.

### BRIEF DESCRIPTION OF THE FIGURES

In the drawings, which are not necessarily drawn to scale, like numerals describe substantially similar components throughout the several views. The drawings illustrate generally, by way of example, but not by way of limitation, various aspects of the present invention.

FIG. 1 is a schematic diagram of a flow cell.

FIG. 2 is a schematic diagram of another flow cell.

FIG. 3 is a schematic diagram of a Prototype 1 flow cell according to the Example.

FIG. 4A is a graph showing the voltage profile of the Prototype 1 flow cell at different current densities.

FIG. 4B is a graph showing variations in pH at the cathode and center compartments with current densities of the Prototype 1 flow cell.

FIG. 4C is a graph showing voltage profiles of the Prototype 1 flow cell at different flow rates.

FIG. 4D is a graph showing electrochemical impedance spectroscopy results for the Prototype 1 flow cell at different flow rates.

FIG. 5A is a graph showing how pH varies at different flow rates at a given current density of the Prototype 1 flow cell.

FIG. 5B is a graph showing pH as a function of C/L for the Prototype 1 flow cell.

FIG. 6A is a graph showing CO₂ capture efficiency as a function of pH for the Prototype 1 flow cell.

FIG. 6B is a graph showing calculated electrochemical energy consumption as a function of C/L as a function of pH for the Prototype 1 flow cell.

FIG. 6C is a graph showing continuous operation of the Prototype 1 flow cell at current density of 8 mA/cm² at flow rate of 40 mL/min.

FIG. 7A is a photograph showing the solution from output of cathode compartment of the Prototype 1 flow cell (seawater was pumped into the Prototype 1 flow cell, current density: 8 mA/cm²; flow rate: 40 ml/min)

FIG. 7B is a schematic diagram of the Prototype 2 flow cell.

FIG. 7C is a graph showing pH vs. current density for different flow cells (seawater was pumped into both the Prototype 1 flow cell and the Prototype 2 flow cell).

FIG. 7D is a graph showing voltage vs. current density for the Prototype 1 flow cell and the Prototype 2 flow cell.

FIG. 8 is a Bjerrum plot of log concentrations of CO₃²⁻, HCO₃⁻, CO₂, OH⁻ and H⁺ as a function of pH of simulated seawater.

FIG. 9 is a plot showing sodium transfer number as functional of normalized current density.

### DETAILED DESCRIPTION OF THE INVENTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.”

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

According to various aspects of the present disclosure, a method of capturing carbon, carbon dioxide in particular, from seawater is disclosed. Carbon dioxide (CO₂) capture from seawater is a viable, long-term solution for addressing legacy carbon pollution on the planet. However, significant challenges to widespread applicability exist in terms of efficiency, cost, and scalability. The present disclosure is directed toward an electrochemical hydrogen-looping system that capitalizes on the generation of the proton (H⁺) and OH⁻ from seawater. The CO₂ capture efficiency surprisingly can be as high as 91% for the instantly disclosed flow cell. Through using the instantly disclosed flow cell, CO₂ can be removed from simulated seawater at an unexpectedly low electric energy consumption rate of 440 kWh ton⁻¹ CO₂, which is a significant reduction of 60% compared with the currently used bipolar membrane electrodialysis technology. The electrochemical hydrogen looping-flow cell with its much lower energy consumption provides an economical approach for direct removal of CO₂ from seawater at practical scale.

The need to reduce and minimize anthropogenic carbon dioxide (CO₂) in the atmosphere has led to extensive research focused on development of technologies that can be used for carbon capture and storage (CCS). CCS from concentrated sources has received a great deal of attention; for example, from power plants that burn fossil fuel and cement plants. On the other hand, capture of dispersed CO₂ from the atmosphere or seawater is another viable option that likely will play an increasingly important role in achieving net-zero emissions. Compared to direct capture of CO₂ from the atmosphere, direct removal of CO₂ from seawater is a promising method of capturing dispersed CO₂ because the concentration of CO₂ in the oceans is 140 times higher than the CO₂ concentration in the atmosphere and the ocean provides much of the capacity (˜38,000 Gton) for nature carbon sequestration. Besides, well-developed and easily scaled up CO₂ capture technologies make ocean CO₂ removal have a great potential to achieve the Gton (CO₂) per year removal levels.

Capturing CO₂ from seawater requires deploying a flow cell in a littoral environment or offshore. Accordingly, CO₂ capture from seawater in an ocean environment faces significant technical, economic, and environmental challenges, such as high capital and operating costs, corrosion, and ecological considerations. Some of these challenges are being mitigated as more and more energy is being produced from renewable resources such as solar photovoltaic systems and wind turbines, resulting in continuously decreasing electricity generation costs and more interest in the use of electrochemical systems for CCS.

Previous attempts to capture carbon from seawater include bipolar membrane electrodialysis, (BPMED) and electrolytic cation exchange modules (E-CEM), which are two electrochemical approaches that have been explored by splitting the dissolved salt into its corresponding acid and base solutions. The acid produced then reacts with carbonate or bicarbonate in seawater to produce CO₂ through a reaction with the dissolved inorganic carbon. Mixing of basified and acidified seawater results in a weak base solution that can be discharged back to the ocean. The weak base solution may influence the pH of seawater as the Ca²⁺ and Mg²⁺ in fresh seawater will react with hydroxide ions in weak base solution to form solid precipitate.

Widespread deployment of both approaches is limited because of the high cell voltages required lead to high operating costs. The theoretical voltage of the BPMED system is 0.83 V while that of the E-CEM is 1.73 V. The practical operating voltages are even higher when overpotentials are considered—for E-CEM the demonstrated operating potential was as high as ˜7 V at a current density of 10 mA/cm². while BPMED s normally operated at ˜1.9 V at current a density of 10 mA/cm.² More importantly, both the conventional BPMED and E-CEM systems involve the oxygen evolution reaction so the expensive and resource-limited precious metal oxide catalyst are needed, which significantly hinders the potential for large-scale deployment of either systems when competing with electrolysis for hydrogen generation. Although an improved BPMED system has been reported with a lower theoretical voltage of ˜0.36 V, the improved system requires the addition of K₃Fe(CN)₆/K₄Fe(CN)₆, thus increased system complexity remain. As described in further detail herein the instantly disclosed flow cell system(s) are capable of overcoming these deficiencies.

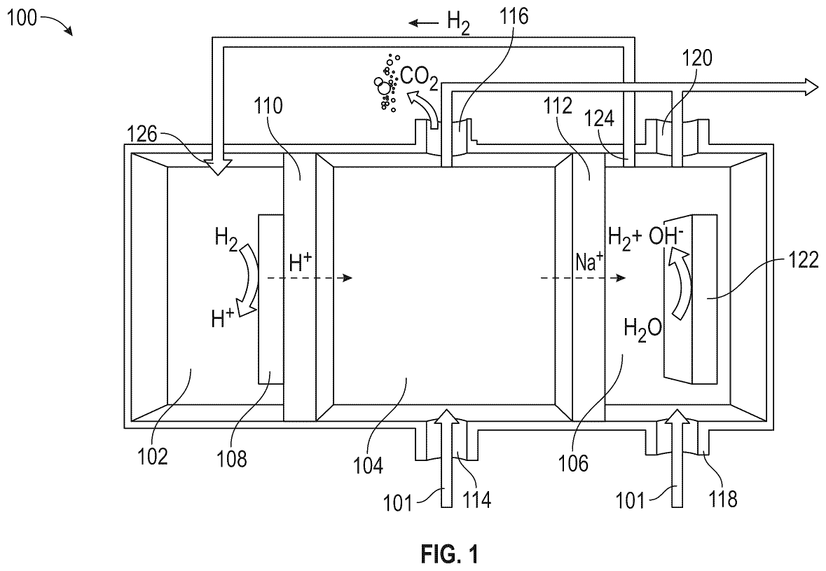

FIG. 1 is a schematic view of flow cell system 100. Flow cell system 100 includes anode compartment 102, center compartment 104, and cathode compartment 106. Anode compartment 102 includes anode 108 and is bounded on one side by proton exchange membrane 110. Center compartment 104 is bounded on opposite sides by proton exchange membrane 110 and sodium ion exchange membrane 112. Center compartment 104 further includes seawater inlet 114 as well as CO₂ and acidified seawater outlet 116. Center compartment 104 is usually filed with a polymeric filler such as a polytetrafluoroethylene bar. Cathode compartment 106 is bounded on one side by sodium ion exchange membrane 112 and includes seawater inlet 118, basified seawater outlet 120, and cathode 122. Cathode compartment 106 further comprises hydrogen outlet 124 and anode compartment 102 includes hydrogen inlet 126 to shuttle hydrogen from cathode compartment 106 to anode compartment 102.

In operation, input seawater 101 flows to center compartment 104 and cathode compartment 106. Input seawater 101 is a complex mixture of 96.5 percent water, 2.5 percent salts, and smaller amounts of other substances, including dissolved inorganic and organic materials, particulates, and a few atmospheric gases. The six most abundant ions of seawater are chloride (Cl⁻), sodium (Na⁺), sulfate (SO²₄⁻), magnesium (Mg²⁺), calcium (Ca²⁺), and potassium (K⁺). By weight these ions make up about 99 percent of all sea salts. The amount of these salts in a volume of seawater varies because of the addition or removal of water locally (e.g., through precipitation and evaporation). The salt content in seawater is indicated by salinity (S), which is defined as the amount of salt in grams dissolved in one kilogram of seawater and expressed in parts per thousand. Salinities in the open ocean have been observed to range from about 34 to 37 parts per thousand (0/00 or ppt), which may also be expressed as 34 to 37 practical salinity units (psu).

Inorganic carbon, bromide, boron, strontium, and fluoride constitute the other major dissolved substances of seawater. Of the many minor dissolved chemical constituents, inorganic phosphorus and inorganic nitrogen are among the most notable, since they are important for the growth of organisms that inhabit the oceans and seas. Seawater also contains various dissolved atmospheric gases, chiefly nitrogen, oxygen, argon, and carbon dioxide. Some other components of seawater are dissolved organic substances, such as carbohydrates and amino acids, and organic-rich particulates. These materials originate primarily in the upper 100 meters (330 feet) of the ocean, where dissolved inorganic carbon is transformed by photosynthesis into organic matter. In some specific examples, seawater 101 can include 0.5 M NaCl and 2.5 mM NaHCO₃.

Oxidation of hydrogen at anode 108 will release two protons per hydrogen molecule (Equation 1). These protons are transported though proton exchange membrane 110 to center compartment 104 where protons react with CO₃^{2- and HCO}₃⁻ to produce acidified seawater and release CO₂ gas for collection (Equation 2 and 3). Anode 108 can be a Pt/C catalyst coated carbon electrode (other catalyst materials can include a Ru/C, Ir/C, or Pd/C) and proton exchange membrane 110 can be a Nafion 212 proton exchange membrane, a cation conducting crosslinked membranes based on sulphonated polystyrene ethylene butylene poly styrene (SPSEBS) and glutaraldehyde (2-10%), and poly (styrene-isobutylene-styrene) copolymers (SO3H SIBS), or a combination thereof.

Anode: H₂−2e⁻→2H⁺ E0=0V (1)

Center Compartment: H⁺+HCO₃⁻→H₂O+CO_{2(g)} (2)

2H⁺+2NaCl→HCl+2Na⁺ (3)

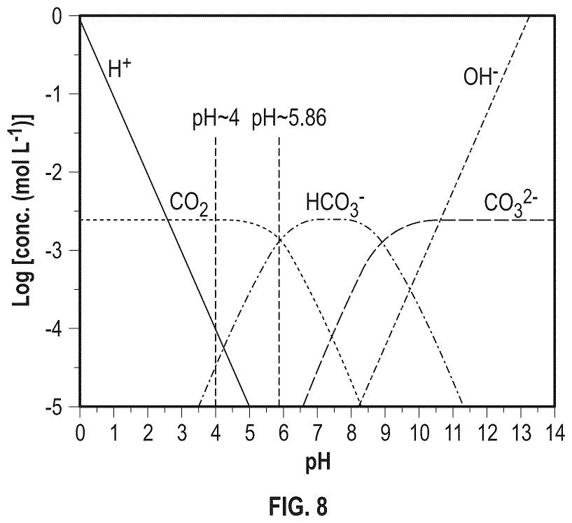

The optimal pH of outlet seawater solution is at the range of 4-5.86 as most of the bicarbonate in seawater will be transformed to CO₂. Concentrations of various constituents across the pH spectrum are shown herein at FIG. 8. Charge neutrality in center compartment 104 is obtained when Na⁺ is transferred to cathode 122 where hydrogen evolution results in the formation of NaOH at cathode 122, thus basifying the solution (Equation 4).

Cathode: H₂O+2Na⁺+2e⁻→H_{2(g)}+2NaOH E⁰=−0.48V (pH=8.1) (4)

As shown in FIG. 1, hydrogen produced at cathode 122 then flows back to anode 108 to compensate for consumption during hydrogen oxidation. Cathode 122 can include a Ru/C catalyst, Ir/C catalyst, or Pd/C catalyst. Cathode 122 can also include cobalt, nickel, iron, manganese, Molybdenum, and tungsten) based carbide or nitrides or phosphides.

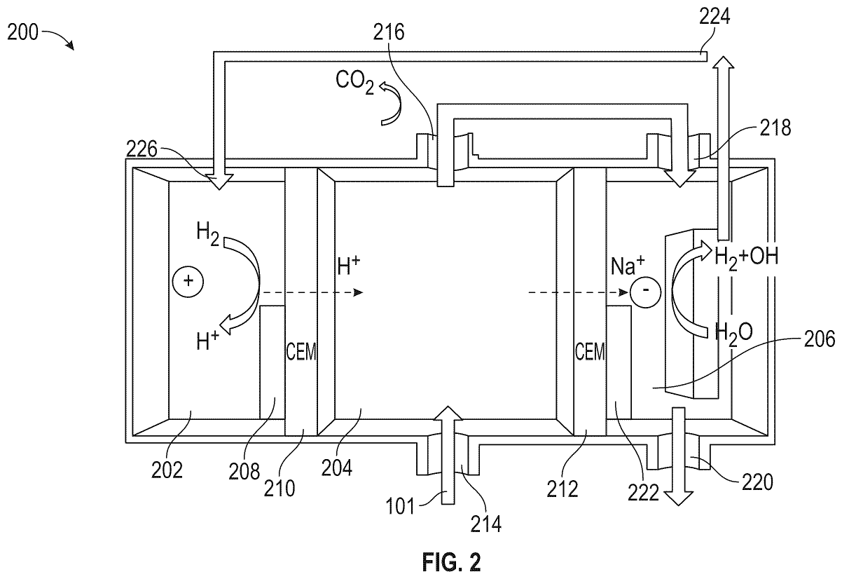

FIG. 2 is a schematic view of flow cell system 200. Flow cell system 200 includes anode compartment 202, center compartment 204, and cathode compartment 206. Anode compartment 202 includes anode 208 and is bounded on one side by proton exchange membrane 210. Center compartment 204 is bounded on opposite sides by proton exchange membrane 210 and sodium ion exchange membrane 212. Center compartment 204 further includes seawater inlet 214 as well as CO₂ and acidified seawater outlet 216. Center compartment 204 is usually filed with a polymeric filler such as a polytetrafluoroethylene bar. Cathode compartment 206 is bounded on one side by sodium ion exchange membrane 212 or other new cation conducting crosslinked membranes based on sulphonated polystyrene ethylene butylene poly styrene (SPSEBS) and glutaraldehyde (2-10%), and poly (styrene-isobutylene-styrene) copolymers (SO3H SIBS) and includes acidified seawater inlet 218, basified seawater outlet 220, and cathode 222. Cathode compartment 206 further comprises hydrogen outlet 224 and anode compartment 202 includes hydrogen inlet 226 to shuttle hydrogen from cathode compartment 206 to anode compartment 202.

Flow cell system 200 can be advantageous in that it can overcome potential fouling issues that may be present in flow cell system 100. Fouling in flow cell system 100 can result from the formation of NaOH cathode compartment 106 that will react with Ca²⁺ and Mg²⁺ from seawater to generate Mg(OH)₂ and CaCO₃ precipitate, resulting in mineral fouling, at the same time, the final pH of the mixture between the CO₂-depleted acidified solution from center compartment 104 and the basified solution from cathode compartment 106 is less than 7 because the formation mineral precipitate will consume the hydroxide ion and consequently the basified solution from the cathode compartment 106 cannot efficiently basify the CO₂-depleted acidified solution. By helping to prevent fouling, flow cell system 200 can provide a sustainable and environmental-friendly pathway to extract CO₂ from seawater because of no mineral fouling issues and no acidified seawater to be discharged to sea.

In both flow cell system 100 and flow cell system 200, the electrochemical reactions at anode compartments 102 and 202 as well as the chemical reactions at center compartments 104 and 204 are the same. But the chemical reactions at cathode compartments 106 and 206 are different. Relative to the chemical reactions at cathode compartment 106, the OH⁻ at cathode 222 will react the proton instead of Ca²⁺ or Mg²⁺ from CO₂-depleted acid solution firstly, finally resulting in the solution with similar pH of the seawater to be discharged back to the ocean. beneficially, the pH of solution at the input of cathode compartment 206 of flow cell system 200 is lower than that of flow cell system 100, resulting in lower theoretical operation voltage.

The voltage required to operate flow cell system 100 or 200 can vary depending on the flow rate of the seawater. For example, at a flow rate of 20 mL/min to 60 mL/min operating voltages of about 0.20 V to about 1.5 V (about 0.30V to about 1 V or about 0.5 V to about 0.8 V) at a current density ranging from about 2 mA/cm² to 40 mA/cm² (5 mA/cm² to 30 mA/cm² or 10 mA/cm² to 20 mA/cm 2). Overall, the electrical energy consumption of flow cell system 100 ranges from about 400 kwh/ton CO₂ to about 600 kwh/ton CO₂ (450 kwh/ton CO₂ to 550 kwh/ton CO₂ or 475 kwh/ton CO₂ to 525 kwh/ton CO₂).

In operation, either flow cell system 100 or 200 can be deployed as a single cell of an array of cells that are deployed in saltwater for the capture of carbon dioxide. Flow cell system 100 or 200 is connected to a power source. Examples of suitable power sources include an onshore power source, offshore power source, or both. Either power source can include a wind turbine power, solar cell power, battery power, hydroelectric power, nuclear power, coal power or a combination thereof. In examples, where the power source is an offshore power source, the power source can be collocated with flow cell system 100 or 200 (e.g., part of any structure including flow cell system 100 or 200) or the power source may be located at a different offshore location and electrically connected via cable.

Captured CO₂ can be processed in any suitable manner. For example, after the CO₂ has been captured, it can be compressed into a supercritical fluid. The CO₂ can be compressed to such a degree that it can be more easily transported. Large volumes of highly pressurized CO₂ can be transported by ship or by pipelines as non-limiting examples. Compression can occur at the capture site or the CO₂ can be transported offsite for compression. The compression process requires its own energy source, which can be shared with the energy source used to power the flow cell(s) or compression can use a separate power source. Compression of CO₂ can use any suitable apparatus or device. For example, compression can use a multi-stage complex compressor(s) and a power-generated cooling process.

The captured CO₂ may be disposed using geological sequestration. Geological sequestration refers to the storage of CO₂ underground in depleted oil and gas reservoirs, saline formations, or deep, un-minable coal beds. In geological sequestration, the CO₂ is injected deep underground, typically around 1 km, where it is stable for a prolonged amount of time.

The relevant parameters in determining a good site for carbon storage are: rock porosity, rock permeability, absence of faults, and geometry of rock layers. The medium in which the CO₂ is to be stored ideally has a high porosity and permeability, such as sandstone or limestone. Sandstone can have a permeability ranging from 1 to 10⁻⁵ Darcy, with a porosity as high as about 30%. The porous rock must be capped by a layer of low permeability which acts as a seal, or caprock, for the CO₂. Shale is an example of a very good caprock, with a permeability of 10⁻⁵ to 10⁻⁹ Darcy. Once injected, the CO₂ plume will rise via buoyant forces, since it is less dense than its surroundings. Once it encounters a caprock, it will spread laterally until it encounters a gap. If there are fault planes near the injection zone, there is a possibility the CO₂ could migrate along the fault to the surface, leaking into the atmosphere.

While trapped in a rock formation, CO₂ can be in the supercritical fluid phase or dissolve in groundwater/brine. It can also react with minerals in the geologic formation to precipitate carbonates. Worldwide storage capacity in oil and gas reservoirs is estimated to be 675-900 Gt CO₂, and in un-minable coal seams is estimated to be 15-200 Gt CO₂. Deep saline formations have the largest capacity, which is estimated to be 1,000-10,000 Gt CO₂.

### EXAMPLES

Various aspects of the present invention can be better understood by reference to the following Examples which are offered by way of illustration. The present invention is not limited to the Examples given herein.

### Experimental Method

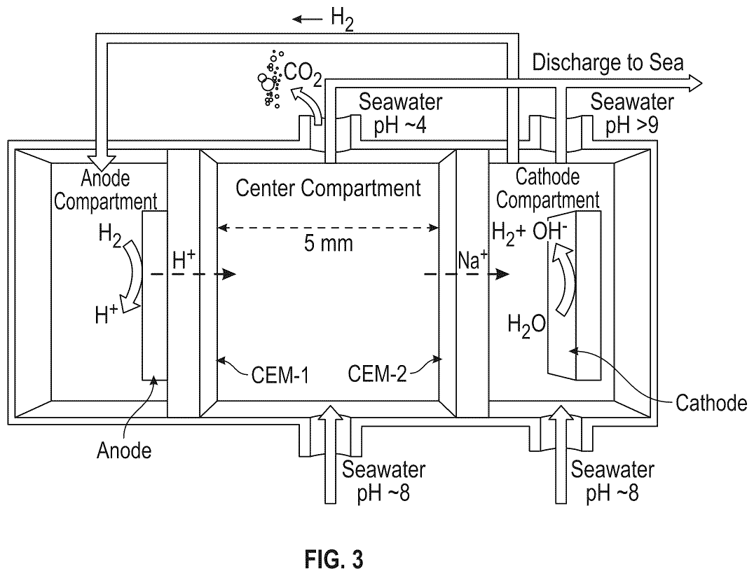

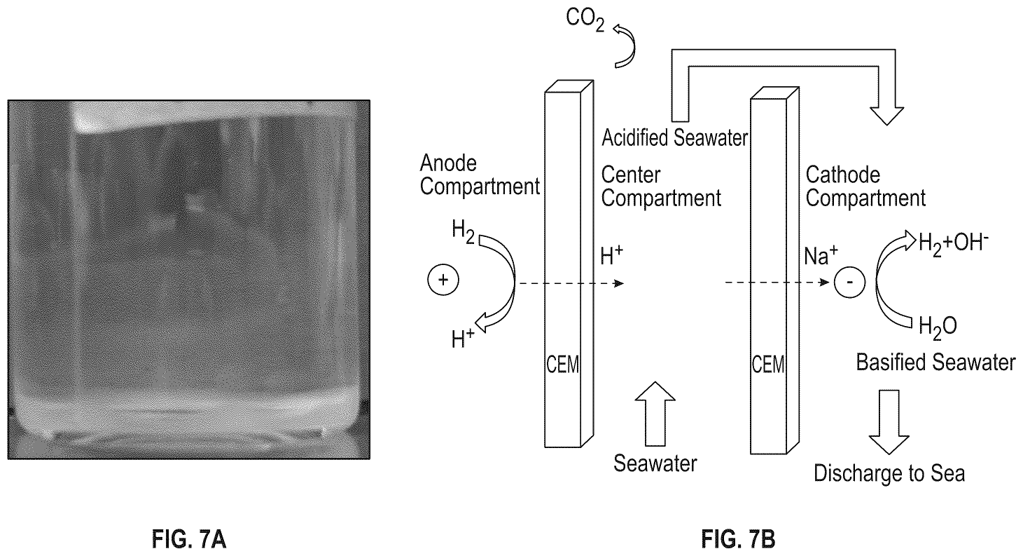

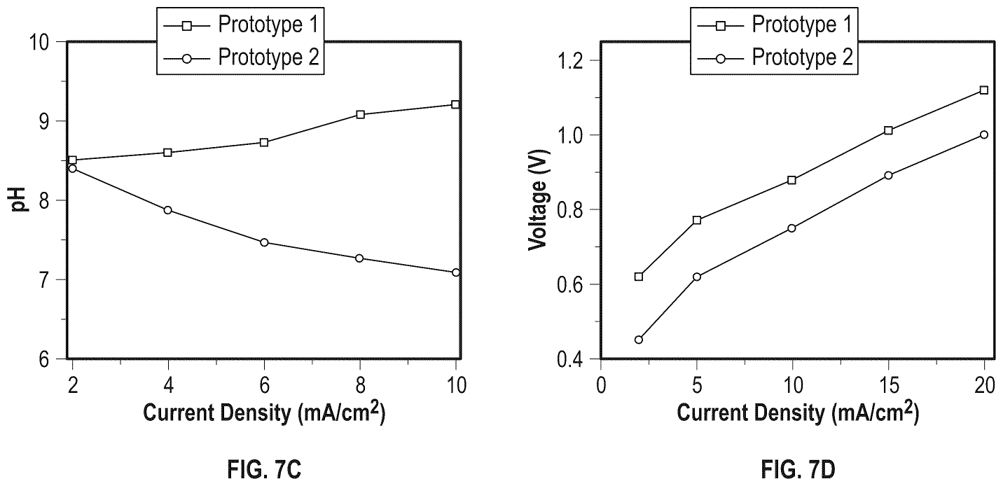

The Prototype 1 flow cell and Prototype 2 flow cell are each a custom-built single cells that includes three compartments: 1) an anolyte compartment, 2) an acidified compartment (center compartment), and 3) a basified compartment (catholyte compartment). As shown in FIGS. 3 and 7A, the center compartment is a 5-mm thick polytetrafluoroethylene bar. To assemble the flow cell, a proton-exchange membrane (Nafion 212) is used to electronically separate the anode and the center compartment while the center compartment and cathode are separated by a sodium ion-exchange membrane produced by soaking a Nafion 212 membrane in 3-M NaCl for two days. Before flow-cell assembly, the sodium ion-exchange membrane is washed with deionized water to remove NaCl residue on the membrane. The simulated seawater for Prototype 1 flow cell is 0.5 M NaCl+2.5 mM NaHCO₃. A Pt/C catalyst coated on carbon paper (Fuel Cell Store) is used for HOR and HER at the cathode and anode, respectively. The cathode, anode, and two cation exchange membranes had the same active area of 34 cm² (i.e., 17 cm×2 cm). A small amount of hydrogen is supplied to the anode compartment to initiate the process before applying the voltage to the cell. When in operation, for Prototype 1 flow cell (FIG. 3), fresh seawater (pH˜8.1) is pumped through the center compartment and cathode half-cell, while for Prototype 2 flow cell, freshwater is only be pumped through the center compartment, and the CO₂ depleted acidified seawater (pH<7) from outlet of center compartment simultaneously flowed to cathode half-cell. The flow rate of seawater flowing through both center and cathode compartments is controlled by peristaltic pump (Cole-Parmer). The pH of the solution from outlet of center and cathode compartment is measured three times for each current density. The pH should be constant for three measurements, the steady state would be confirmed. The acidified simulated seawater from the outlet of the center compartment of Prototype 1 flow cell is collected and a 20 mL aliquot of the solution is placed in a 100 mL glass beaker and then degassed for half an hour in a vacuum box. The carbon content of acidified seawater after degassing is measured using a total carbon analyzer (vario TOC cube for TOC analyzer, Elementar). The CO₂ capture efficiency is defined as:

$$CO 2 capture efficiency = \frac{\begin{matrix}carbon content in fresh seawater - \\ carbon content in acidified seawater\end{matrix}}{carbon content in fresh seawater}$$

The CO₂-depleted acidified solution then is combined with the basified solution, resulting in a weak base solution to be discharged. The flow rate of simulated seawater is controlled by a peristaltic pump. The pH values of the simulated seawater from the outlet of center compartment and cathode are measured by a pH meter (PH700, APEAR Instrument). Electrochemical impedance spectroscopy measurements (CHI 760, CH Instruments, Inc)) are carried out between the anode and cathode compartments, and the impedance drop across of the flow cell is calculated. Continuous operation of our Prototype 1 flow cell at current density of 8 mA/cm² at a flow rate of 40 mL/min was performed. SEM-EDX (JSM-IT200, JEOL) was to characterize the chloride content in proton exchange membrane after 100 minutes operation, and a negligible trace amount of chlorides was found.

### Results

As shown in FIG. 3, oxidation of hydrogen at the anode will release two protons per hydrogen molecule (Equation 1). These protons are transported though the Nafion 212 proton exchange membrane to the center compartment where protons react with CO₃²⁻ and HCO₃⁻ to produce acidified seawater and release CO₂ gas for collection (Equation 2 and 3).

The optimal pH of outlet seawater solution is at the range of 4-5.86 as most of the bicarbonate in seawater will be transformed to CO₂. Charge neutrality in the central compartment is obtained when Na⁺ is transferred to the cathode where hydrogen evolution results in the formation of NaOH at the cathode, thus basifying the solution (Equation 4). As shown in FIG. 3., hydrogen produced at the cathode then flows back to the anode to compensate for consumption during hydrogen oxidation.

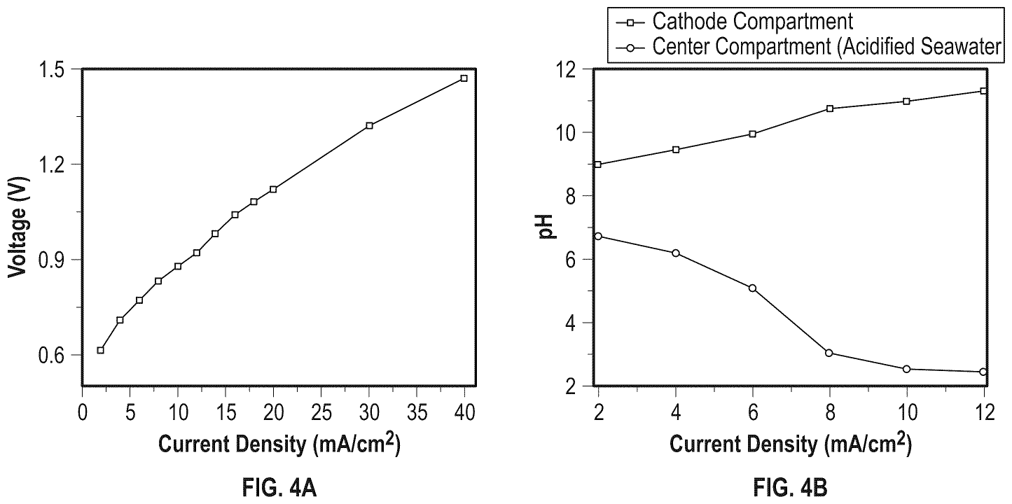

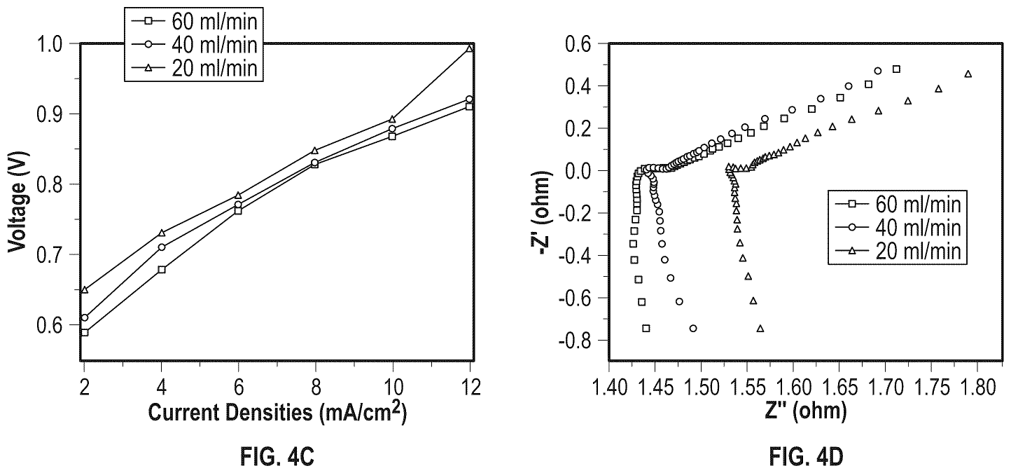

The CO₂-depleted acidified solution from the center compartment combines with the basified solution from the cathode compartment, creating a mixture solution to be discharged back into the ocean. As such, the Prototype 1 flow cell provides an inexpensive, efficient, and simple way to capture CO₂ from seawater. The working mechanism of the Prototype 1 flow cell capitalizes on the small potential difference of HOR/HER in acidic and basic solutions, respectively, to achieve the low-voltage electrochemical CO₂ extraction. The fast kinetics of the HOR/HER and the mild operating conditions enable the flow cell to separate CO₂ from seawater with low operating and capital costs. Performance of the Prototype 1 flow cell under various operation conditions is shown in FIG. 4.

Cell voltage as a function of the operating current density under a flow rate of 40 mL/min is shown in FIG. 4A. As shown, a low operating voltage of 0.62 V can be achieved at a current density of 2 mA/cm², which is lower than the theoretical voltage of BPMED-1 (˜0.83 V). As a comparison, a much higher operating voltage of ˜1 V is required for BPMED-2 cells at the same current density of 2 mA/cm² even when K₃Fe(CN)₆/K₄Fe(CN)₆ additives are used to assist salt splitting. Under similar operating conditions, this translates to a 38% energy saving. It is worth noting that the theoretical voltage (˜0.36 V) of improved BPMED-2 cells is lower than the Prototype 1 flow cell (˜0.48 V), but with assistance of fast kinetics of hydrogen oxidation/evolution on Pt catalyst, a much lower applied voltage could be achieved at the same current density for Prototype 1 flow cell. At a current density of 40 mA/cm², it was further observed that the applied voltage on the flow cell increases to 1.5 V (FIG. 4A). At the same voltage, the operating current density of 40 mA/cm² on the Prototype 1 flow cell is four times higher than reported for the BPMED, FIG. 4B shows the pH change at the center compartment of the cell and the cathode compartment as a function of current densities. The solutions in both compartments are simulated seawater (pH˜8.1). After applying the voltage on the Prototype 1 flow cell, the proton from the HOR in the anode half-cell passes through the membrane to the center compartment to acidify the seawater. As a result, the pH of the effluent seawater decreases. The simulated seawater measured at the outlet of the center compartment has a pH of <7, which decreases as current density increases, indicating successful acidification of the solution for the removal of CO₂. This result also corroborates the observed basification of the cathode half-cell due to HER (Equation 4) in which a pH >7 is observed at the outlet of cathode compartment, increasing as the current density increases. Outlet streams from the center compartment and cathode half-cell are mixed, which can be discharged back to the ocean. Because the number of H⁺ ions generated from the oxidation of hydrogen gas at the anode is equivalent to the number of electrons from the applied electrical current, at the same time, the sodium ion transport number for sodium ion exchange membrane can maintain a constant of ˜0.75 value within the operable pH and current density ranges, which indicates most of the generated proton at the anode will not transfer to the cathode compartment. As a result, a higher proton concentration will result in a lower pH value in the center compartment as the current density increases. FIG. 4B shows that the pH decreased to 2.4 when the current density increased to 12 mA/cm². FIG. 4C shows the observed voltage on the flow cell as a function of charge current densities at three different flow rates. As expected, the operation voltage increased as the current density increased at each flow rate. For example, the voltage of ˜0.62 V was obtained at a current density of 2 mA/cm² at the flow rate of 40 mL/min, and the voltage increased to 0.9 V when the applied current density increased to 12 mA/cm². The ohmic resistance of the flow cell dominate the resistance for the flow cell at three different flow rates, and the ohmic resistance of the flow cell decreased from 1.531 ohm at the flow rate of 20 ml/min to 1.439 ohm at the flow rate of 60 ml/min (FIG. 4D), further demonstrating that an increasing flow rate can reduce the concentration polarization. For example, the voltage decreased to 0.55 V at a current density of 2 mA/cm² when the flow rate increased to 60 mL/min.

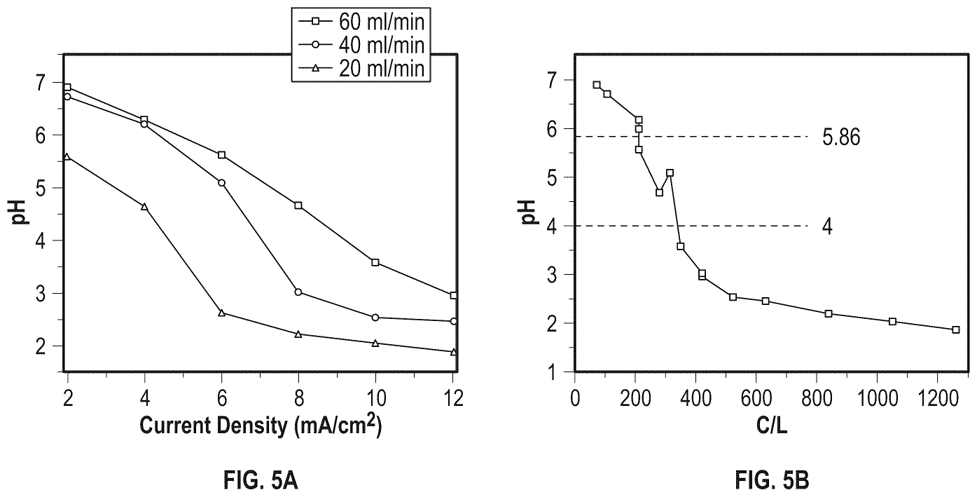

To further quantify the flow cell performance, normalized current density was defined as total charge per volume of seawater (coulombic/volume, C/L) flowing through the cell. As shown in FIG. 5A, increasing flow rate at each current density decreases the values of C/L due to the increased volume of the seawater, which results in a lower proton concentration and a higher pH for the seawater at the outlet of the center compartment. On the other hand, increasing current density at each flow rate can increase the proton concentration and lower the pH of seawater at the outlet of the center compartment. FIG. 5B shows the pH as a function of the C/L. A higher normalized current density translates to more protons being introduced into the simulated seawater in the center compartment of the Prototype 1 flow cell, leading to lower pH. Conversely, at a lower C/L, the pH of the simulated seawater stream in the center compartment was not sufficiently low to convert the majority of HCO₃⁻ into dissolved CO₂. The trend of decreasing pH with increasing C/L is observed for most C/L values, with one abnormal value observed at 315 C/L (current density: 6 mA/cm², flow rate: 40 mL/min). The 5.1 pH value is higher than the 4.66 pH value detected at 280 C/L (current density: 8 mA/cm², flow rate: 60 ml/min). The cause of this abnormity is under further investigation.

The electrochemical energy consumption of the Prototype 1 flow cell is an important parameter for evaluating its performance for capturing CO₂ from the simulated seawater. Electrochemical energy consumption in this study is defined as the amount of electrical energy required (in kilowatt hour [kWh]) for the Prototype 1 flow cell divided by the amount of captured CO₂ (in mass [kg]) as shown in the following Equation 5.

$$Electricity energy consumption = \frac{Current * voltage * time}{\begin{matrix}Flow rate * time * ( mass of CO 2 in seawater per liter ) * \\ CO 2 capture efficiency\end{matrix}} \qquad ( 5 )$$

where

$$\frac{Current}{Flow rate * time} = normalized current density ;$$

therefore, electricity energy consumption could be simplified to:

$$Electricity energy consumption = \frac{Normalized current density * time * voltage}{mass of CO 2 in seawater per liter * CO 2 capture efficiency} \qquad ( 6 )$$

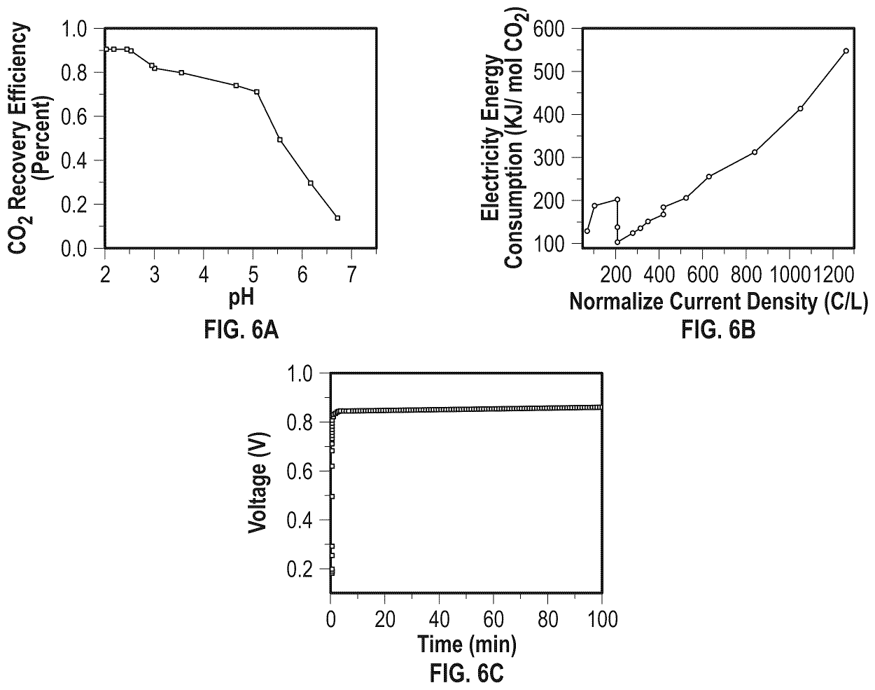

High utilization of proton in center compartment is relevant to achieve high CO₂ capture efficiency and lower energy consumption in the Prototype 1 flow cell due to the competing reactions of the CO₂ generation through proton reacting with bicarbonate in seawater, and the hydrogen generation at cathode after transporting through the sodium ion exchange membrane. Generally, bicarbonate in fresh seawater (pH˜8.1) is almost completely transformed to CO₂ when the solution pH decreases to 4. FIG. 6A shows that the CO₂ capture efficiency could be increased by decreasing the pH and a high CO₂ capture efficiency of ˜91% could be obtained at an even lower pH of ˜2. FIG. 6B shows the calculated electric energy consumption as a function of the C/L. As shown in FIG. 6C, the lowest electric energy consumption of 104 KJ/mol CO₂ (660 kWh ton⁻¹) for the Prototype 1 flow cell was at a C/L of 210 (at a current density of 2 mA/cm², at flow rate of 20 mL/min, and pH˜5.5). A study on BPMED reported that acidified simulated seawater at pH˜4.7 yielded the lowest electrochemical energy consumption of ˜155 KJ/mol CO₂ (˜900 kwhton⁻¹), which is approximately about 1.5× higher than that of the Prototype 1 flow cell. Higher C/L values corresponding to lower pH values can yield high CO₂ capture efficiency; however, the improvement in CO₂ capture efficiency tapers off when the pH is lower than 4 because most of the CO₂ was already released from seawater at pH˜4. Similar results also were reported in CO₂ extraction from seawater using BPMED and E-CEM. As such, further increasing the C/L will result in increasing energy consumption with little benefit. On the other hand, lower C/L (e.g., <210 C/L) cannot efficiently acidify the simulated seawater, leading to lower CO₂ capture efficiency and higher electrochemical energy consumption. As shown in FIG. 6C, continuous operation of our Prototype 1 flow cell at current density of 8 mA/cm² at a flow rate of 40 mL/min, the voltage is stable for continuous operation of 100 minutes.

It is noted that the simulated seawater (0.5 M NaCl+2.5mMNaHCO₃) instead of real seawater was circulated into Prototype 1 flow cell because the formation of NaOH at cathode compartment of Prototype 1 flow cell will react with Ca²⁺ and Mg²⁺ from real seawater to generate Mg(OH)₂ and CaCO₃ precipitate (FIG. 7A), resulting in mineral fouling, at the same time, the final pH of the mixture between the CO₂-depleted acidified solution from the center-compartment and the basified solution from the cathode half-call is less than 7 because the formation mineral precipitate will consume the hydroxide ion and consequently the basified solution from the cathode half-cell cannot efficiently basify the CO₂-depleted acidified solution.

The Prototype 2 flow cell can provide a sustainable and environmental-friendly pathway to extract CO₂ from seawater because of no mineral fouling issues and no acidified seawater to be discharged to sea. FIG. 7B shows the schematics of the three-cell configuration of a Prototype 2 flow cell. The configuration of Prototype 2 flow cell is exactly same to Prototype 1 flow cell. When in operation, for the Prototype 1 flow cell (FIG. 3), fresh seawater (pH˜8.1) will be pumped through the center compartment and cathode half-cell, while for the Prototype 2 flow cell, freshwater will only be pumped through the center compartment, and the CO₂ depleted acidified seawater (pH<7) from outlet of center compartment simultaneously flowed to cathode half-cell. For both the Prototype 1 flow cell and Prototype 2 flow cell, the electrochemical reactions at two electrodes and the chemical reactions at center compartment are the same. But the chemical reactions at the cathode compartment are totally different. For the Prototype 2 flow cell, the OH⁻ at cathode will react the proton instead of Ca²⁺ or Mg²⁺ from CO₂-depleted acid solution firstly, finally resulting in the solution with similar pH of the seawater to be discharged back to the ocean. More importantly, the pH of solution at the input of cathode of the Prototype 2 flow cell is lower than that of the Prototype 1 flow cell, resulting in lower theoretical operation voltage. Furthermore, at each specific current density, the solutions at the output of cathode of the Prototype 2 flow cell show similar pH (FIG. 7C) as seawater and no white precipitate could be observed. However, the pH of the solution at the output of cathode of the Prototype 1 flow cell is ˜9 (FIG. 7C), and white precipitate in the solution could be observed (FIG. 7A). As such the Prototype 2 flow cell provides, an extremely low energy consumption, an efficient and self-sustaining way to capture CO₂ from acidified seawater. A significant voltage increase was observed for both the Prototype 1 flow cell and an unoptimized Prototype 2 flow cell in FIG. 7D with increase current density. The Prototype 2 flow cell has ˜200 mV lower than the Prototype 1 flow cell at each specific current density because pH differential at two separate half-cells for the Prototype 2 flow cell is smaller than that for the Prototype 1 flow cell. Specifically, extremely low voltage of ˜0.45 V could be achieved for the Prototype 2 flow cell at current density of 2 mA/cm².

TABLE 1

| | Prototype 2 | Prototype 1 | | | |
|---|---|---|---|---|---|
| Technology | flow cell | flow cell | BPMED-1 | BPMED-2 | E-CEM |
| Theoretical | 0.36 | 0.48 | 0.83 | 0.36 | 1.71 |
| voltage (V) | | | | | |
| Electricity | ~500 | ~600 | ~1500 (need to | ~920 (need to | ~2000 |
| energy | | (Discharge | overcome slow | overcome slow | |
| consumption | | acid seawater | kinetics of | kinetics of water | |
| (kwh/ton | | mineral | water splitting | splitting on bipolar | |
| CO₂) | | fouling) | on bipolar | membrane) | |
| | | | membrane) | | |
| Current | 50 | 50 | <10 | <10 | 50 |
| density | | | | | |
| (mA/cm²) | | | | | |
| Cost ($/ton | ~60 | ~80 | >160 | >100 | >200 |
| CO₂) | | | | | |
| Operation | Mild | Mild | Need extra | Need extra toxic and | High corrosion on |
| conditions | | | Na₂SO₄/H₂SO₄ | nonstable | anode |
| | | | | K₃Fe(CN)₄/K₄Fe(CN)₄ | |
| Summary | Extremely | Low energy | High energy | High cost, toxic | High energy |
| | low energy | consumption; | consumption, | membrane issues and | consumption |
| | consumption | not | membrane | slow kinetics of water | |
| | sustainable | sustainable | issues; slow | splitting on bipolar | |
| | | | kinetics of | membrane | |
| | | | water splitting | | |
| | | | on bipolar | | |
| | | | membrane. | | |

Table 1 summarizes the energy consumption and operation cost comparison for the Prototype 2 flow cell, the Prototype 1 flow cell, BPMED, and E-CEM. Compared with other CO₂ capture technologies from seawater, e.g., BPMED-1 [˜1400 kwh/ton CO2]; BPMED-2 [˜900 kwh/ton CO₂] and E-CEM [˜20000 kwh/ton CO2], the lowest energy consumption of ˜400 kwh/ton CO₂ could be estimated for the Prototype 2 flow cell. In addition to lower energy consumption and mild operating voltage, the Prototype 2 flow cell avoids the use of expensive and resource limited titanium plate material. More important, both the conventional BPMED and E-CEM systems involve the oxygen evolution reaction that usually demand IrO₂ as catalyst, known for high price and severe resource scarcity, which significantly hinders the potential for large-scale deployment of either system when competing with electrolysis for hydrogen generation. The Prototype 2 flow cell uses a cation exchange membrane that is widely used and understood and that has proven stability when compared to the bipolar membranes used in the BPMED system. Furthermore, the BPMED system requires tank storage of strongly acidic electrode solutions containing (0.2 M H₂SO₄/0.25 M Na₂SO₄) or K₄[Fe(CN)₆]. On the contrary, the Prototype 2 flow cell only needs a small amount of hydrogen to start the operation and the anolyte is seawater instead of externally supplied chemical solution, thus greatly reducing the balance-of-plant cost and system complexity for both large-scale centralized plants and dispersed deployment as modular systems. Besides, comparing to the Prototype 1 flow cell, the key invention of the Prototype 2 flow cell is to flow CO₂ depleted acidified seawater to cathode compartment, leading to 1) a much lower theoretical cell voltage (dependent on pH at cathode compartment); 2) a similar pH of seawater to be discharged to sea directly; 3) no mineral fouling. Furthermore, this could be a standalone technology if operated using energy produced on-site from renewable resources such as wind, solar photovoltaic, or even wave, current, or tidal energy from the oceans. However, one challenge for the AFC technology is that the crossover of sodium, chloride and other chemical ions can be potentially absorbed on Pt catalyst at the anode leading to a lower efficiency. A periodical cleaning of the anode surface may be needed for long-term operation.

The Examples herein demonstrate direct CO₂ extraction from seawater using the Prototype 2 flow cell. Compared with other available technologies, the AFC flow cell shows significant benefits. First, substantially lower energy consumption (˜400 kwh·ton⁻¹ CO₂) can be achieved because of its low theoretical cell voltage and fast HOR·HER reactions. Second, its mild operating conditions (e.g., low anodic potential) further enable the use of inexpensive carbon bipolar plates and non-fluoride cation exchange membranes instead of expensive Nafion membranes. Third, the system can be scaled up by adopting a bipolar plate design similar to those used in electrodialysis flow cells and redox flow battery systems, thus making it suitable for both modular and centralized deployment. Fourth, the Prototype 2 flow cell is a self-sustaining system that greatly reduce the capital cost. By replacing the oxygen evolution reaction by hydrogen oxidation at the anode side, the Prototype 2 flow cell can be designed to use lower-cost and more abundant catalyst and component materials to lower the capital cost of the system.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Supplemental Information for Examples

BPMED-1: The theoretical potential of BPMED is dertermined by using the difference in pH between the acidfied and basified seawater. The pH values for acified and basified seawater are 0 and 14, respectively, Therefore, for BPMED-1, the theoretical potential is calculated as shown below:

0.059*(pH14−pH0)=0.83 (V) (7)

BPMED-2: The pH values of acified and basified seawater are 4.6 and 10.6, respectively. Therfore, their theoretical potential is

0.059*(pH10.6−pH4.6)=0.36 (V). (8)

### E-CEM:

The cathode reaction for E-CEM is same as that of Prototype 1 and Prototype 2.

Anode: H₂O−2e⁻→0.5O₂+2H⁺ E⁰=1.23V (9)

Therefore, the theoretical potential of Prototype 1 and Prototype 2 is

E_{Anode}−E_{Cathode}=1.23−(0.48)=1.71 (V). (10)

Calculation of electrochemical electricity energy consumption (the concentration of CO₂ in seawater is 2.5 mmol/L) is described here:

BPMED-1: The electricity energy consumption is 242 KJ/mol CO₂:¹

$$\frac{KJ}{mol} CO 2 = ( \frac{1}{3.6} ) \frac{wh}{mol} CO 2 \qquad ( 11 )$$

Therefore, the electricity energy consumption will be:

$$242 \frac{KJ}{mol} CO 2 = 242 * ( \frac{1}{3.6} ) \frac{wh}{mol} CO 2 = 67.22 \frac{wh}{mol} CO 2 \qquad ( 12 )$$

$$By integating Eqs . ( 5 ) and ( 8 ) :$$

$$= 67.22 * \frac{22.85 kwh}{ton} CO 2 ∼ 1500 \frac{kwh}{ton} CO 2 \qquad ( 13 )$$

BPMED-2: The electrochemical electricity energy consumption is 0.98 kwh/kg CO₂ (980 kwh/1 ton CO₂).²

E-CEM: The power, flow rate and current applied on the E-CEM was 265 W, 1,900 mL/min (114 L/hr), and 20 A, respectively.⁵ The total mass of CO₂ flowing through the E-CEM in 1 hr will be 114 (L)×2.5 (mmol/L)×44 (g/mol)=12.54 g. Assuming the CO₂ capture efficiency is 100%, then the electrochemical electricity energy consumption will be: 265 WH÷12.54 g CO₂=21.13 w/g CO₂=21.13 kWh÷kg CO₂=21,130 kWh/ton CO₂.

According to the working mechanism of Prototype 1 and Protype 2, the cation (proton and sodium ion) transport rate though the sodium ion exchange membrane is equal to the generation rate of proton (G_{H}_{⁺} in mol s⁻¹), which can be expressed by:

$${G}_{{H}^{+}} = \frac{I}{F} \qquad ( 14 )$$

where I (in A) is the current applied on the Prototype 1 and Protype 2 flow cell, and F is the Faraday constant (96485 s A mol⁻¹).

The total number of protons (in mol L⁻¹) transported from anode to the center compartment is given by the generation rate of protons divided by the flow rate (Q, in L s⁻¹) in the center compartment.

$${[ {H}^{+} ]}_{Total} = \frac{{G}_{{H}^{+}}}{Q} \qquad ( 15 )$$

It is difficult to quantify the sodium transfer number by the change on sodium ion concentration at center and cathode compartment because this change is negligible. In the Prototype 1 and Protype 2 flow cell, protons have three functions: 1) react with carbonate/bicarbonate ([H⁺]_{Bio/carbonate}) to extract CO²; 2) further acidify seawater in the center compartment ([H⁺]_{acidify}); 3) transport through the sodium ion exchange membrane to the cathode compartment ([H⁺]ₜᵣₐₙₛₚₒᵣₜ). To achieve a charge-neutral solution in the center compartment, the number of sodium ions and protons that transport through the sodium ion exchange membrane can be determined using Equation S15, which is related to the change in concentrations of CO₃²⁻, HCO₃⁻, OH⁻ and H⁺ from the initial values. Therefore, the sodium ion transfer number could be described by:

$${t}_{{Na}^{+}} = \frac{{[ {H}^{+} ]}_{Bio / carbonate} + {[ {H}^{+} ]}_{acidify}}{{[ {H}^{+} ]}_{Total}} \qquad ( 16 )$$

The [H⁺]_{Bio/carbonate} could be calculated by:

[H⁺]_{Bio/carbonate}=×[HCO₃⁻]+2Δ[CO₃²⁻]+OH⁺ (17)

The [H⁺]_{acidify} is related to the pH of acidified seawater as follows:

[H⁺]_{acidify}=10^{-pH} (18)

The carbonate species in seawater are related by the following equilibria:

CO₂+H₂O [symbol] HCO₃⁻+H⁺ [symbol] CO₃²⁻+2H⁺ (19)

The stoichiometric equilibrium constants used to describe the carbonate system in seawater are determined using Equations 20 and 21:

$$\begin{matrix}{K}_{1} = \frac{[ {HCO}_{3}^{-} ] [ {H}^{+} ]}{[ {CO}_{2} ]} & ( 20 ) \\ {K}_{2} = \frac{[ {CO}_{3}^{2 -} ] [ {H}^{+} ]}{[ {HCO}_{3}^{-} ]} & ( 21 )\end{matrix}$$

where K1=10^{-5.86}, pK1=5.86, and K2 is 10^{-8.92}, pK2=8.92.
The total dissolved inorganic carbon content could be described by the following reaction:

DIC=[HCO₃⁻]+[CO₃²⁻]+[CO₂] (22)

For simulated seawater, the dissolved inorganic carbon is 2.5 mM. We used carbonate alkalinity (CA) to express the charge balance of the simulated seawater at normal conditions

CA=[HCO₃⁻]+2[CO₃²⁻] (23)

Therefore, the concentration of [HCO₃⁻], [CO₃²⁻] and [CO₂] as a function of H⁺ (pH) is expressed by the following equations:

$$\begin{matrix}[ {HCO}_{3}^{-} ] = DIC / ( 1 + \frac{[ {H}^{+} ]}{{K}_{1}} + \frac{{K}_{2}}{[ {H}^{+} ]} ) & ( 24 ) \\ [ {CO}_{3}^{2 -} ] = DIC / ( 1 + \frac{[ {H}^{+} ]}{{K}_{1}} + \frac{[ {H}^{+} ]}{{K}_{1} {K}_{2}} & ( 25 ) \\ [ {CO}_{2} ] = DIC / ( 1 + \frac{{K}_{1}}{[ {H}^{+} ]} + \frac{{K}_{1} {K}_{2}}{{[ {H}^{+} ]}^{2}} & ( 26 )\end{matrix}$$

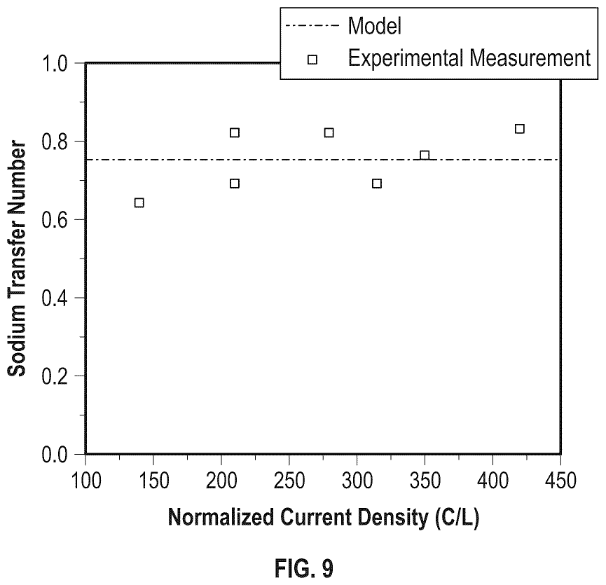

Therefore, once the pH of the acidified simulated seawater is measured, the change on [HCO₃⁻], [CO₃²⁻] and [OH₋] could be calculated by the Equation. (24), (25), and (26). Using Equations (14), (15), (16), (17), and (18), sodium ion transfer could be calculated, as shown in FIG. 9.

A zero-dimension equilibrium model has been developed to estimate the relationship between the current density and sodium transfer number, t_{Na}_{⁺}, for the Prototype 1 and Protype 2 flow cell. The model is developed and modified according to a H₂-recycling electrochemical system model. The sodium ion flux across the membrane J_{Na}_{⁺} is calculated by:

$${J}_{{Na}^{+}} = \frac{Q}{A} ( {C}_{{Na}^{+} , 0} - {C}_{{Na}^{+} , 1} ) \qquad ( 27 )$$

where C_{Na}_{⁺}_{,0} and C_{Na}_{⁺}_{,1} are the concentrations of Na⁺ at the inlet and outlet of the acidifying compartment, respectively. Q is the seawater flow rate in the acidifying compartment, and A is the area of the membrane. The total ionic current J_{c} through the membrane is calculated by

J_{c}=J_{Na}_{⁺}+J_{H}_{⁺} (28)

where J_{H}_{⁺} is the molar flux of H⁺ through the membrane. According to the Nernst-Planck equation, J_{Na}_{⁺} and J_{H}_{⁺} are calculated by:

$$\begin{matrix}{J}_{{Na}^{+}} = - D \cdot {c}_{x} ( \frac{{df}_{{Na}^{+}}}{dx} + {f}_{Na} + \frac{d ϕ}{dx} ) & ( 29 ) \\ {J}_{{H}^{+}} = - a \cdot D \cdot {c}_{x} ( \frac{{df}_{{H}^{+}}}{dx} + {f}_{H} + \frac{d ϕ}{dx} ) & ( 30 )\end{matrix}$$

where D is the diffusivity of Na⁺ in membrane, a is the ratio between the diffusion coefficient of H⁺ and Na⁺, cₓ is the fixed charge density of the membrane, f_{Na}_{⁺} is the concentration fraction of Na⁺, f_{H}_{⁺} is the concentration fraction of H⁺ with f_{Na}_{⁺}+f_{H}_{⁺}=1, and ϕ is the dimensionless electric potential normalized by

$$\frac{F}{RT} .$$

By applying the linear approximation on the concentration in the membrane, the differential terms can be calculated by:

$$\begin{matrix}\frac{{df}_{{Na}^{+}}}{dx} = \frac{{f}_{{Na}^{+} , c} - {f}_{{Na}^{+} , a}}{δ} & ( 31 ) \\ \frac{{df}_{{H}^{+}}}{dx} = \frac{{f}_{{H}^{+} , c} - {f}_{{H}^{+} , a}}{δ} & ( 32 )\end{matrix}$$

where the subscripts a and c stand for the acidifying and cathode sides of the membrane, and δ is the membrane thickness. The fractions f_{Na}_{⁺} and f_{H}_{⁺} are approximated by:

$$\begin{matrix}{f}_{{Na}^{+}} = \frac{{f}_{{Na}^{+} , c} - {f}_{{Na}^{+} , a}}{2} & ( 33 ) \\ {f}_{{H}^{+}} = \frac{{f}_{{H}^{+} , c} - {f}_{{H}^{+} , a}}{2} & ( 34 )\end{matrix}$$

By combining Eqs. (29) to (34) into (28), the total ionic current can be calculated

by:

$${J}_{c} = - D \cdot \frac{{c}_{x}}{δ} \{ ( a - 1 ) \cdot ( {f}_{{H}^{+} , c} - {f}_{{H}^{+} , c} ) + [ 1 + ( a - 1 ) \frac{{f}_{{H}^{+} , c} + {f}_{{H}^{+} , a}}{2} ] d ϕ \} \qquad ( 35 )$$

With given inlet concentration C_{Na}_{⁺}_{,0} and flow rate Q, by applying the bisection iteration method to try different values of C_{Na}_{⁺}_{,1} in Eqs. (27) and (29), the total ionic flux J_{c} calculated from Equation (35) can converge to the desired system current density, and then the sodium transfer number can be calculated by J_{Na}_{⁺}/J_{c}. The model calculation predicts that the t_{Na}_{⁺} can maintain the constant of ˜0.75 at the operable pH and current density. There is a small discrepancy between the measured data and the modeled data. We believe this small discrepancy is acceptable when the measurement accuracy of pH also is taken into consideration.

### EXEMPLARY ASPECTS

The following exemplary aspects are provided, the numbering of which is not to be construed as designating levels of importance:

Aspect 1 provides a method of capturing carbon from seawater, the method comprising:
flowing input seawater comprising bicarbonate and having a pH greater than 8 through a center compartment of an electrolytic cell, wherein the center compartment is disposed between an anode compartment and a cathode compartment of the electrolytic cell;
acidifying the input seawater in the center compartment with a proton, to form acidified seawater;
generating carbon dioxide in the center compartment comprising reaction of the proton with the bicarbonate from the input seawater;
flowing acidified seawater out of the center compartment;
contacting the acidified seawater with hydroxide or a hydroxide salt from the cathode compartment to generate basified seawater having a pH greater than 9; and
flowing hydrogen generated in the cathode compartment to the anode compartment.

Aspect 2 provides the method of Aspect 1, further comprising discharging the basified seawater.

Aspect 3 provides the method of any of Aspects 1 or 2, further comprising storing or sequestering the carbon dioxide.

Aspect 4 provides the method of any of Aspects 1-3, wherein the basified seawater is generated by reacting the acidified seawater with sodium in the cathode compartment.

Aspect 5 provides the method of any of Aspects 1-4, wherein the basified seawater is generated by reacting the input seawater with sodium in the cathode compartment.

Aspect 6 provides the method of any of Aspects 1-5, wherein a portion of the input seawater is inputted into the cathode compartment and basified via OH—, and then combined with the acidified seawater to form the basified seawater.

Aspect 7 provides the method of any of Aspects 1-6, wherein the proton is passed from the anode compartment to the center compartment through a proton exchange membrane.

Aspect 8 provides the method of any of Aspects 1-7, wherein sodium from the input seawater is passed from the center compartment to the cathode compartment through a sodium ion exchange membrane.

Aspect 9 provides the method of any of Aspects 1-8, wherein the anode compartment comprises a Pt/C catalyst coated carbon paper.

Aspect 10 provides the method of any of Aspects 1-9, wherein the cathode compartment comprises a Pt/C catalyst coated carbon electrode.

Aspect 11 provides the method of any of Aspects 1-10, wherein the center compartment comprises polytetrafluoroethylene disposed therein.

Aspect 12 provides the method of Aspect 11, wherein the polytetrafluoroethylene is in the form of a bar.

Aspect 13 provides the method of any of Aspects 1-12, further comprising applying a voltage across the anode compartment and cathode compartment.

Aspect 14 provides the method of Aspect 13, wherein the voltage is in a range of from about 0.30V to about 0.90V.

Aspect 15 provides the method any of Aspects 13 or 14, wherein the voltage is in a range of from about 0.50V to about 0.60V.

Aspect 16 provides the method of any of Aspects 13 -15, wherein a current density generated is in a range of from about 5 mA/cm2 to about 40 mA/cm2.

Aspect 17 provides the method of any of Aspects 1-16, wherein a flow rate of the input seawater is in a range of from about 10 mL/min to about 70 mL/min.

Aspect 18 provides the method of any of Aspects 1-17, wherein a flow rate of the input seawater is in a range of from about 20 mL/min to about 60 mL/min.

Aspect 19 provides the method of any of Aspects 1-18, wherein the input seawater comprises 0.5 M NaCl and 2.5 mM NaHCO₃.

Aspect 20 provides a source of carbon dioxide captured according to the method of any of steps 1-19.

Aspect 21 provides a system for capturing carbon dioxide from input seawater, the system comprising an electrolytic cell comprising:
an anode compartment comprising a Pt/C catalyst coated carbon paper;
a cathode compartment comprising a Pt/C catalyst coated carbon electrode;
a center compartment abutting the anode compartment and cathode compartment and comprising a polytetrafluoroethylene bar disposed therein.

Aspect 22 provides the system of Aspect 21, wherein the cathode compartment and the center compartment are in fluid communication with each other.

Aspect 23 provides the system of any of Aspect 21 or 22, wherein the center compartment comprises an inlet to allow input seawater to enter and an outlet for acidified seawater and carbon dioxide to exit.

Aspect 24 provides the system of any of Aspects 21-23, wherein the cathode compartment comprises an inlet to allow input seawater to enter.

Aspect 25 provides the system of any of Aspects 21-24, wherein the cathode compartment comprises an inlet to receive acidified seawater from the center compartment.

Aspect 26 provides the system of any of Aspects 21-25, wherein the cathode compartment comprises an outlet for discharging basified seawater.

Aspect 27 provides the system of any of Aspects 21-26, wherein the cathode compartment provides a second outlet to flow hydrogen gas to an inlet of the anode compartment.

Aspect 28 provides the system of any of Aspects 21-27, wherein the input seawater is acidified and carbon dioxide is generated by reacting the input seawater with a proton generated by oxidizing H₂ in the anode compartment.

Aspect 29 provides the system of any of Aspects 21-28, wherein the acidified seawater is basified to have a pH greater than 9 by reacting the acidified seawater with sodium in the cathode compartment.

Aspect 30 provides the system of any of Aspects 21-29, further comprising a power source electrically coupled to the anode compartment and the cathode compartment.

Aspect 31 provides the system of Aspect 30, wherein the power source is adapted to deliver a voltage in a range of from about 0.30V to about 0.90V.

Aspect 32 provides the system of any of Aspects 30 or 31, wherein the power source is adapted to deliver a voltage in a range of from about 0.50V to about 0.60V.

Aspect 33 provides the system of any of Aspects 21-32, wherein the input seawater comprises 0.5 M NaCl and 2.5 mM NaHCO₃.

Aspect 34 provides the system of any of Aspects 21-33, wherein the system consumes about 400 to about 500 kWh/ton of carbon dioxide produced.

Aspect 35 provides the system of any of Aspects 21-34, wherein the system consumes about 430 to about 470 kWh/ton of carbon dioxide produced.

Aspect 36 provides the system of any of Aspects 21-35, wherein electrolytic cell is a first electrolytic cell and the system further comprises a second electrolytic cell corresponding to the first electrolytic cell.

What is claimed is:

1. A method of capturing carbon from seawater, the method comprising:
flowing input seawater comprising bicarbonate and having a pH greater than 8 through a center compartment of an electrolytic cell, wherein the center compartment is disposed between an anode compartment and a cathode compartment of the electrolytic cell;
acidifying the input seawater in the center compartment with a proton, to form acidified seawater;
generating carbon dioxide in the center compartment comprising reaction of the proton with the bicarbonate from the input seawater;
flowing acidified seawater out of the center compartment;
contacting the acidified seawater with hydroxide or a hydroxide salt from the cathode compartment to generate basified seawater having a pH greater than 9; and
flowing hydrogen generated in the cathode compartment to the anode compartment.

2. The method of claim 1, further comprising discharging the basified seawater.

3. The method of claim 1, further comprising storing or sequestering the carbon dioxide.

4. The method of claim 1, wherein the basified seawater is generated by reacting the acidified seawater with sodium in the cathode compartment.

5. The method of claim 1, wherein the basified seawater is generated by reacting the input seawater with sodium in the cathode compartment.

6. The method of claim 1, wherein a portion of the input seawater is inputted into the cathode compartment and basified via OH—, and then combined with the acidified seawater to form the basified seawater.

7. The method of claim 1, wherein the proton is passed from the anode compartment to the center compartment through a proton exchange membrane.

8. The method of claim 1, wherein sodium from the input seawater is passed from the center compartment to the cathode compartment through a sodium ion exchange membrane.

9. The method of claim 1, wherein the anode compartment comprises a Pt/C catalyst coated carbon paper.

10. The method of claim 1, wherein the cathode compartment comprises a Pt/C catalyst coated carbon electrode.

11. The method of claim 1, wherein the center compartment
comprises polytetrafluoroethylene disposed therein.

12. The method of claim 1, wherein the polytetrafluoroethylene is in the form of a bar.

13. The method of claim 1, further comprising applying a voltage across the anode compartment and cathode compartment.

14. The method of claim 1, wherein the voltage is in a range of from about 0.30V to about 0.90V.

15. The method of claim 1, wherein the voltage is in a range of from about 0.50V to about 0.60V.

16. The method of claim 1, wherein a current density generated is in a range of from about 5 mA/cm2 to about 40 mA/cm2.

17. The method of claim 1, wherein a flow rate of the input seawater is in a range of from about 10 mL/min to about 70 mL/min.

18. The method of claim 1, wherein a flow rate of the input seawater is in a range of from about 20 mL/min to about 60 mL/min.

19. The method of claim 1, wherein the input seawater comprises 0.5 M NaCl and 2.5 mM NaHCO₃.

20. A source of carbon dioxide captured according to the method of claim 1.

21. A system for capturing carbon dioxide from input seawater, the system comprising an electrolytic cell comprising:
an anode compartment comprising a Pt/C catalyst coated carbon paper;
a cathode compartment comprising a Pt/C catalyst coated carbon electrode;
a center compartment abutting the anode compartment and cathode compartment and comprising a polytetrafluoroethylene bar disposed therein.

22. The system of claim 21, wherein the cathode compartment and the center compartment are in fluid communication with each other.

23. The system of claim 21, wherein the center compartment comprises an inlet to allow input seawater to enter and an outlet for acidified seawater and carbon dioxide to exit.

24. The system of claim 21, wherein the cathode compartment comprises an inlet to allow input seawater to enter.

25. The system of claim 21, wherein the cathode compartment comprises an inlet to receive acidified seawater from the center compartment.

26. The system of claim 21, wherein the cathode compartment comprises an outlet for discharging basified seawater.

27. The system of claim 21, wherein the cathode compartment provides a second outlet to flow hydrogen gas to an inlet of the anode compartment.

28. The system of claim 21, wherein the input seawater is acidified and carbon dioxide is generated by reacting the input seawater with a proton generated by oxidizing H₂ in the anode compartment.

29. The system of claim 21, wherein the acidified seawater is basified to have a pH greater than 9 by reacting the acidified seawater with sodium in the cathode compartment.

30. The system of claim 21, further comprising a power source electrically coupled to the anode compartment and the cathode compartment.

31. The system of claim 30, wherein the power source is adapted to deliver a voltage in a range of from about 0.30V to about 0.90V.

32. The system of claim 30, wherein the power source is adapted to deliver a voltage in a range of from about 0.50V to about 0.60V.

33. The system of claim 21, wherein the input seawater comprises 0.5 M NaCl and 2.5 mM NaHCO₃.

34. The system of claim 21, wherein the system consumes about 400 to about 500 kWh/ton of carbon dioxide produced.

35. The system of claim 21, wherein the system consumes about 430 to about 470 kWh/ton of carbon dioxide produced.

36. The system of claim 21, wherein electrolytic cell is a first electrolytic cell and the system further comprises a second electrolytic cell corresponding to the first electrolytic cell.
